(19) United States
(12) Patent Application Publication
(10) Pub. No.: US 2011/0069006 A1
(43) Pub. Date: Mar. 24, 2011

(54) METHOD AND SYSTEM FOR DETECTING A FINGER CONTACT ON A TOUCHPAD

(75) Inventors: Xiaoning LIU, Shenzhen (CN); Bangjun HE, Shenzhen (CN); Yung YANG, Shenzhen (CN)

(73) Assignee: BYD COMPANY LIMITED, Shenzhen (CN)

(21) Appl. No.: 12/868,516

(22) Filed: Aug. 25, 2010

(30) Foreign Application Priority Data
Sep. 18, 2009 (CN) 200910190235.0

(51) Int. Cl. G09G 5/08

(52) U.S. Cl. 345/157

(57) ABSTRACT

A method for executing a scroll control operation on a touchpad includes detecting a first simultaneous execution of a first operation executed by a first pointing object, and a second operation executed twice in succession by a second pointing object, wherein the first operation includes detecting a presence of the first pointing object on the touchpad, and the second operation includes contacting with the touchpad by the second pointing object, followed by lifting the second pointing object off the touchpad subsequently. The method further includes triggering a scroll control function in response to the detection of the first simultaneous execution of the first operation and the two successive second operations.

### CROSS-REFERENCE TO RELATED APPLICATION

This application claims foreign priority benefits under 35 U.S.C.§119 of Chinese Patent Application Serial No. 200910190235.0, filed on Sep. 18, 2009, the content of which is incorporated herein by reference in its entirety.

### TECHNICAL FIELD

The present invention relates generally to a touchpad, and more particularly to a scrolling method for touchpad.

### BACKGROUND

Although the keyboard remains a primary input device of a computer, the prevalence of graphical user interfaces (GUIs) may require use of a mouse or other pointing device such as a trackball, joystick, touchpad or the like.

Touchpads are commonly used on portable electronic devices due to their compact size. FIG. 1 shows a conventional touchpad 10, on which three regions are divided for a cursor control region 11, a horizontal scroll region 12 and a vertical scroll region 13. In operation, cursor control and scrolling control are performed on their respective, specific regions. For example, when a user wants to move a cursor on a corresponding window, the user operates on the cursor control region 11. To view portions of documents outside a user interface window, the user may operate the corresponding scroll regions to scroll the documents upward, downward, leftward or rightward.

### SUMMARY OF THE INVENTION

According to one exemplary embodiment of the invention, a method for executing a scroll control operation on a touchpad includes detecting a first simultaneous execution of a first operation executed by a first pointing object, and a second operation executed twice in succession by a second pointing object. The first operation includes detecting a presence of the first pointing object on the touchpad. The second operation includes a contact with the touchpad by the second pointing object, followed by lifting the second pointing object off the touchpad subsequently. The method further includes triggering a scroll control function in response to the detection of the first simultaneous execution of the first operation and the two successive second operations.

According to another exemplary embodiment of the invention, a device for executing a scroll control operation on a touchpad comprises a sensing unit and a processing unit. The sensing unit is configured to detect a first simultaneous execution of a first operation executed by a first pointing object and a second operation executed twice in succession by a second pointing object. The first operation includes a contact with the touchpad by the first pointing object. The second operation includes a contact with the touchpad by the second pointing object, followed by lifting the second pointing object off the touchpad subsequently. The processing unit is configured to trigger the scroll control operation in response to the detection of the first simultaneous execution of the first operation and the two successive second operations.

According to another exemplary embodiment of the invention, a method for executing a scroll control operation on a touchpad includes predefining at least a first region and a second region on the touchpad, the first region and the second region associated with a first scrolling direction and a second scrolling direction, respectively. The method further includes detecting a presence of a first pointing object on the touchpad and detecting an operation executed twice in succession by a second pointing object in the presence of the first pointing object, the operation including a contact with the touchpad by the second pointing object, followed by lifting the second pointing object off the touchpad subsequently. The method further includes triggering a scroll control operation in the respective scrolling direction in response to the detection of the two successive operations.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 illustrates a touchpad device according to the prior art;

FIG. 2 is a flow chart describing a method for executing a scroll control operation on a touchpad device according to one exemplary embodiment of the present invention;

FIG. 3A and FIG. 3B are schematic diagrams describing a scroll control operation on a touchpad device according to one exemplary embodiment of the present invention;

FIG. 4 is a schematic diagram describing terminating a scrolling control operation on a touchpad device according to another exemplary embodiment of the present invention;

FIG. 5 is a schematic diagram describing a scrolling control operation on a touchpad device according to another exemplary embodiment of the present invention;

FIG. 6 is a schematic diagram describing a scrolling control operation on a touchpad device according to another exemplary embodiment of the present invention; and

FIG. 7 is a schematic diagram describing a scrolling control operation on a touchpad device according to another exemplary embodiment of the present invention.

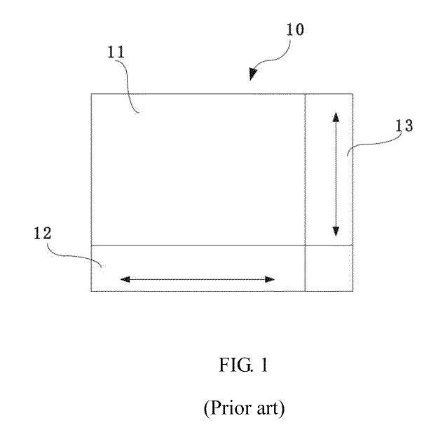

### DETAILED DESCRIPTION OF THE PREFERRED

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, a number of components or objects may be described herein in the singular, plural or as being “at least one” or “one or more.” It should be understood, however, that notwithstanding any particular quantity with which a component or object may be described herein, unless explicitly stated otherwise, the component or object may be in any of a number of different quantities, from the singular to the plural. Like numbers refer to like elements throughout.

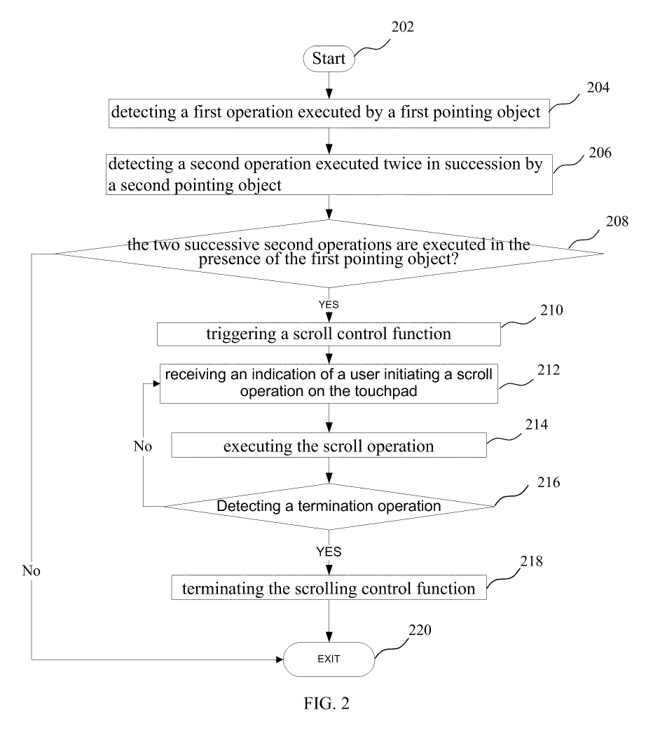

FIG. 2 is a flow chart describing a method for executing a scroll control operation on a touchpad according to one exemplary embodiment of the present invention (“exemplary” as used herein referring to “serving as an example, instance or illustration”). Referring to FIG. 2, the execution process may start at step S202 and proceed to detecting a first operation at step S204. In the first operation, a first pointing object, e.g., a first finger, may come into contact with the touchpad, which may be sensed and detected by a sensing unit. During the execution of the first operation, two successive second operations may be executed at step S206. In executing the second operation, the sensing unit may sense and detect a second pointing object, e.g., a second finger, quickly touching the touchpad and lifting off the touchpad. If the first operation and the two successive second operations are simultaneously detected at step S208, a scroll control function may be triggered by a processing unit at step S210. On the other hand, if the first operation and the two successive second operations are not simultaneously executed, the process will jump to step S220 to terminate the execution process. If the scroll control function is triggered at step S208, the surface of the touchpad that receives the execution process may then be switched from providing cursor control function to provide the scroll control function. An indication of a user initiating a scroll operation over the touchpad is then received and detected at step S212. In response to the user's initiation, the scroll operation is accordingly executed on the touchpad at step S214. Then user may be able to operate corresponding scroll regions to scroll documents upward, downward, leftward or rightward. When a termination operation is detected by the processing unit at step S216, i.e., another simultaneous execution of the first operation and the two successive second operations is detected again, or a sliding operation on the touchpad is detected by the sensing unit at step S216, the scroll control function may be terminated by the processing unit at step S218. The execution process is then terminated at step S220. If no termination operation is detected at step S216, the procedure may proceed to step S212.

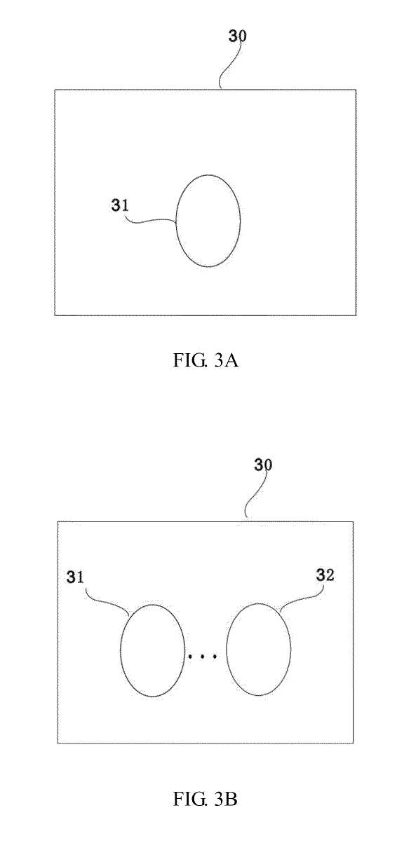

FIG. 3A and FIG. 3B are schematic diagrams describing a scroll control operation on a touchpad 30 according to one exemplary embodiment of the present invention. As illustrated in FIG. 3A, a first pointing object 31 (e.g., a first finger) is resting on the touchpad 30, which is accordingly referred as “a first operation” executed by the first finger 31. The first finger 31 in contact with the touchpad 30 may be sensed and detected by a sensing unit (not shown). In FIG. 3B, a second pointing object 32 (e.g., a second finger) is placed on the touchpad 30, followed by lifting the second pointing object 32 off the touchpad 30. This operation, accordingly referred as “a second operation,” may be executed twice in succession in the presence of the first finger 31 in contact with the touchpad 30. The two successive second operations are also referred as tapping twice or double click. Detection of the simultaneous execution of the first operation and the two successive second operations may then trigger the scroll control function.

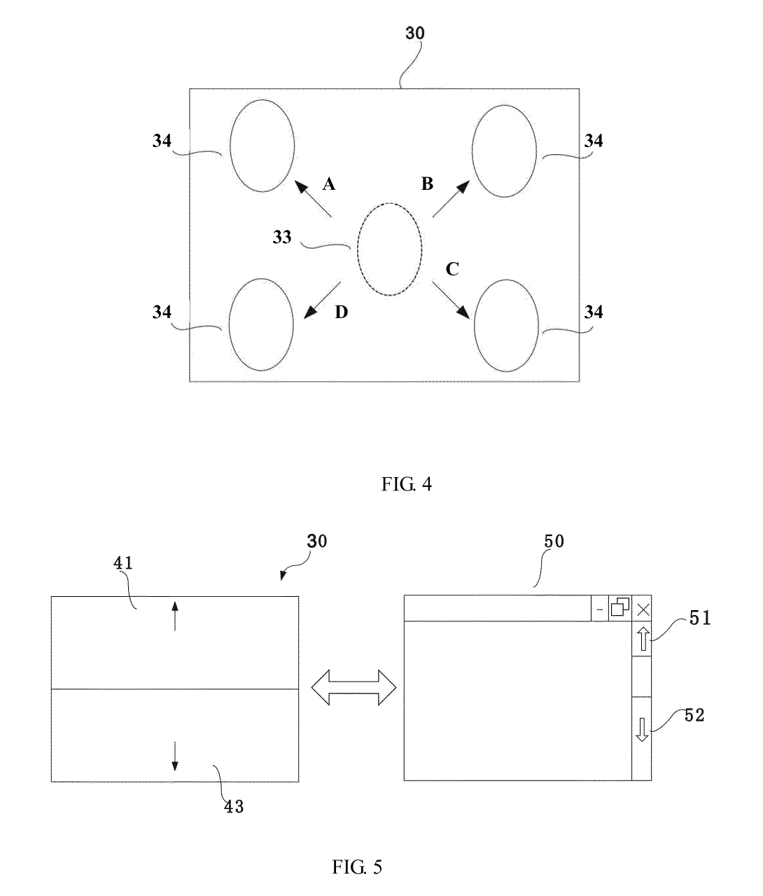

In one exemplary embodiment, the scroll control function may be terminated by another simultaneous execution of the first operation and the two successive second operations. In another exemplary embodiment, as shown in FIG. 4, sliding a finger on the touchpad 30 from a first place 33 to a second place 34 in any direction, for example, directions A, B, C and D, may terminate the scroll control function.

FIG. 5 is a schematic diagram describing a scrolling control operation on a touchpad 30 according to another exemplary embodiment of the present invention. As illustrated in FIG. 5, a first region 41 and a second region 42 are predefined on the touchpad 30. Each of the first region 41 and the second region 42 is associated with a respective scrolling direction. For instances, the first region 41 may be associated with an upward scrolling direction 51 on a user interface 50. The second region 42 may be associated with a downward scrolling direction 52 on the user interface 50. In operation, when a user rests a first finger on the first region 41 and double clicks by a second finger in the same region, the scroll control function associated with the first region 41 may be triggered. The first region 41 that may be provided cursor control function is then switched to provide the scroll control function. The touchpad 30 may sense operations on its surface by a sensing unit (not shown) and may communicate with a processing unit (not shown) using varieties of communication protocols, such as a PS/2 protocol or a USB protocol.

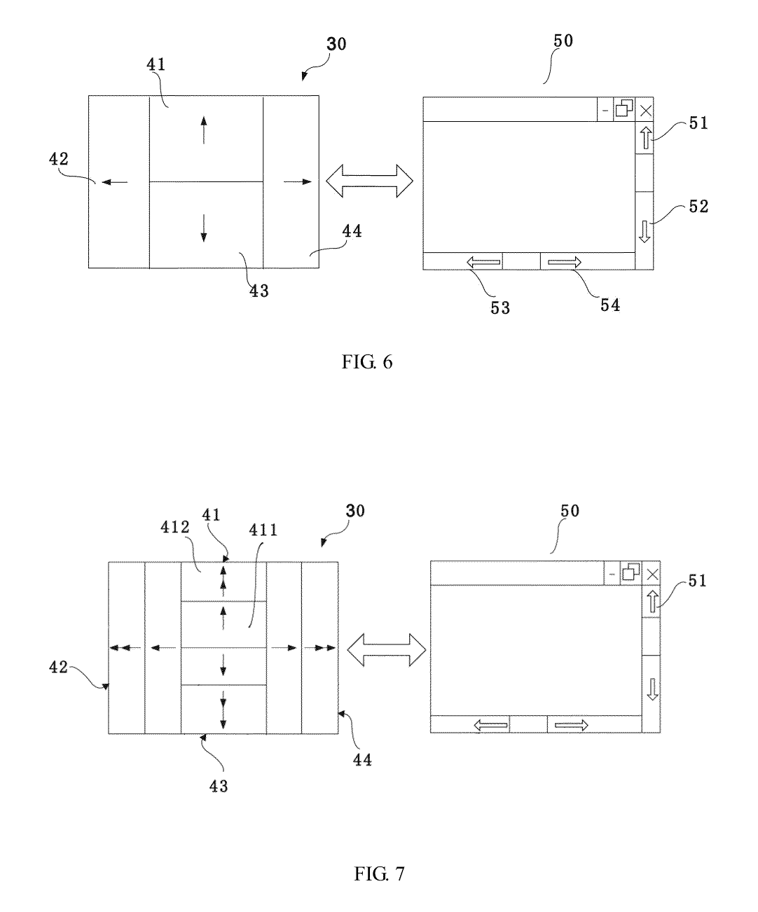

FIG. 6 is a schematic diagram describing a scrolling control operation on a touchpad device according to another exemplary embodiment of the present invention. As illustrated in FIG. 6, four regions, 41, 42, 43, and 44 are predefined on the touchpad 30. Similar to what described in FIG. 5, each of the four regions may be associated with a respective scrolling direction on the user interface 50. For instances, region 41 may be associated with upward scrolling direction 51. Region 42 may be associated with downward scrolling direction 52. Region 43 may be associated with leftward scrolling direction 53. Region 44 may be associated with rightward scrolling direction 54. In operation, when a user places a first finger on one of the four regions, and double click in the same region, the scroll control function associated with this specific region may be triggered.

FIG. 7 is a schematic diagram describing a scrolling control operation on a touchpad device according to another exemplary embodiment of the present invention. Similar to FIG. 6, the four main regions 41, 42, 43, 44 are predefined on the touchpad 30. Each region is associated with a scrolling direction on the user interface 50. In this embodiment, each of the four regions is further divided into two sub-regions, thereby providing different scrolling rates in one direction. For an instance, the first region 41 may be further divided into two sub-regions 411 and 412. Accordingly, sub-region 411 and sub-region 412 may provide different scrolling rates in upward direction 51.

According to one aspect of the present invention, the touchpad may include, for example, a sensing unit and a processing unit. When a user's first finger is resting on the touchpad, the contact with the touchpad may be sensed by the sensing unit, which may be embodied in a number of different manners, such as in the form of a touch-sensitive surface. The sensing unit may simultaneously sense the user's second finger double clicks. The processing unit may trigger the scroll control function in response to the placement of the first finger simultaneous with the second finger's double clicks. The processing unit may be embodied in a number of different manners, such as a CPU (Central Processing Unit), microprocessor, coprocessor, controller and/or various other processing devices including integrated circuits such as ASIC (Application Specification Integrated Circuit), FPGA (Field Programmable Gate Array) or the like. As will be appreciated, the processing unit may include or otherwise be configured to communicate with memory, such as volatile memory and/or non-volatile memory, which may store data received or calculated by the processing unit, and may also store one or more software applications, instructions or the like for the processing unit to perform functions associated with operation of the device in accordance with exemplary embodiments of the present invention.

All or a portion of the system of the present invention, such as all or portions of the processing unit, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method for executing a scroll control operation on a touchpad, comprising the steps of:
detecting a first simultaneous execution of a first operation executed by a first pointing object, and a second operation executed twice in succession by a second pointing object, wherein the first operation includes a presence of the first pointing object on the touchpad, and the second operation includes a contact with the touchpad by the second pointing object, followed by lifting the second pointing object off the touchpad subsequently; and
triggering a scroll control function in response to the detection of the first simultaneous execution of the first operation and the two successive second operations.

2. The method of claim 1, further comprising predefining a first region and a second region on the touchpad, the first region and the second region associated with a first scrolling direction and a second scrolling direction, respectively.

3. The method of claim 2, further comprising:
receiving, from the touchpad, an indication of a user initiating a scroll operation on one of the first region or the second region; and in response thereto,
executing the scroll operation in the corresponding scrolling directions.

4. The method of claim 3, further comprising:
detecting a termination operation on the touchpad; and
terminating the scrolling control function in response to the termination operation.

5. The method of claim 4, further comprising detecting a second simultaneous execution of the first operation and the two successive second operations, and terminating the scroll control function in response to the second simultaneous execution.

6. The method of claim 4, further comprising detecting a sliding operation of an object on the touchpad, and terminating the scroll control function in response to the sliding operation.

7. The method of claim 2, wherein at least one of the first region or the second region is associated with a first scrolling rate, and wherein the method further comprises predefining at least one sub-region in at least one of the first region or the second region, wherein the at least one sub-region is associated a second, different scrolling rate than the first scrolling rate.

8. The method of claim 1, further comprising predefining four regions on the touchpad, wherein the four predefined regions are associated with an upward scrolling direction, downward scrolling direction, leftward scrolling direction and rightward scrolling direction, respectively.

9. A device for executing a scroll control operation on a touchpad, the device comprising:
a sensing unit configured to detect a first simultaneous execution of a first operation executed by a first pointing object and a second operation executed twice in succession by a second pointing object, wherein the first operation includes a contact with the touchpad by the first pointing object, and the second operation includes contacting with the touchpad by the second pointing object, followed by lifting the second pointing object off the touchpad subsequently; and
a processing unit configured to trigger the scroll control operation in response to the detection of the first simultaneous execution of the first operation and the two successive second operations.

10. The device of claim 9, wherein the sensing unit is further configured to receive an indication of a user initiating a scroll operation over the touchpad, and execute the scroll operation in response to the detection.

11. The device of claim 9, wherein the sensing unit is further configured to detect a termination operation executed on the touchpad.

12. The device of claim 11, wherein the processing unit is further configured to terminate the scroll control function in response to the detection of a termination operation.

13. A method for executing a scroll control operation on a touchpad, comprising the steps of:
predefining at least a first region and a second region on the touchpad, the first region and the second region associated with a first scrolling direction and a second scrolling direction, respectively;
detecting a presence of a first pointing object on the touchpad;
detecting an operation executed twice in succession by a second pointing object in the presence of the first pointing object, the operation including a contact with the touchpad by the second pointing object, followed by lifting the second pointing object off the touchpad subsequently; and
triggering a scroll control function in the respective scrolling direction in response to the detection of the two successive operations.

14. The method of claim 13, further comprising:
receiving an indication of a user initiating a scroll operation on one of the first region or the second region; in response thereto,
executing the scroll operation in corresponding scrolling directions;
detecting a termination operation on the touchpad; and
terminating the scrolling control function in response to the detection of the termination operation.

15. The method of claim 14, wherein the scroll operation further comprises presenting a pointing object on the touchpad on one of the first region or the second region.

16. The method of claim 14, wherein the termination operation further comprises presenting a first pointing object on the touchpad, and during the presence of the first pointing object, twice contacting with the touchpad by the second pointing object, each contact followed by lifting the second pointing object off the touchpad.

17. The method of claim 14, wherein the termination operation includes a sliding operation by a pointing object on the touchpad.

18. The method of claim 13, wherein at least one of the first region or the second region is associated with a first scrolling rate, and wherein the method further comprises predefining at least one sub-region in at least one of the first region or the second region, wherein the at least one sub-region is associated a second, different scrolling rate than the first scrolling rate.

19. The method of claim 13, further comprising predefining a third region and a fourth region on the touchpad, wherein the each of the predefined regions are associated with an upward scrolling direction, downward scrolling direction, leftward scrolling direction and rightward scrolling direction, respectively.

20. The method of claim 19, further comprising predefining at least one sub-region in one of the predefined regions, wherein at least one of the predefined regions is associated with a first scrolling rate, wherein the at least one sub-region is associated with a second, different scrolling rate than the first scrolling rate.
